(19) United States
(12) Patent Application Publication
(10) Pub. No.: US 2013/0091905 A1
(43) Pub. Date: Apr. 18, 2013

(54) ANTI-THEFT DEVICE INCLUDING A STRAP AND METHOD OF USE

(71) Applicant: David W. Brown, Cumberland, RI (US)

(72) Inventor: David W. Brown, Cumberland, RI (US)

(73) Assignee: DISPLAY TECHNOLOGIES, INC., Johnston, RI (US)

(21) Appl. No.: 13/275,270

(22) Filed: Oct. 17, 2011

(51) Int. Cl. E05B 73/00; B23P 11/00

(52) U.S. Cl. 70/15; 29/428

(57) ABSTRACT

An anti-theft device for use with a product includes a housing for receiving a portion of the product therein, a strap to secure the housing to the product, a locking assembly to deter removal of the anti-theft device, and a detachment portion to affect removal of the anti-theft device. An EAS sensor may also be provided. The locking assembly includes at least a first portion and at least a second portion that engage each other in a locked position to secure the housing to the product. The detachment portion enables a portion of the anti-theft device to be more readily severed in order to remove the anti-theft device from the product. In one embodiment, the strap is adjustable so that the length of the strap can be adjusted about a periphery of the product during application of the anti-theft device.

### TECHNICAL FIELD

This invention relates generally to an anti-theft device including a strap and, more specifically, to an anti-theft device including a strap and a locking assembly for use with a product such as a battery to deter theft of the same.

### BACKGROUND

It is well known in the art of theft deterrence to use electronic article surveillance (EAS) sensors in order to discourage the theft of consumer products. In use, EAS sensors trigger an alarm if not detached or disarmed before the product is removed from the store. For many products, electronic sensors have been very effective in deterring theft. Often, the EAS sensors are hidden in a device that is attached to a product. However, such sensors can be difficult to attach to certain products, for example tools and fixtures, and can often be easily removed from such items even when attached. One item that is difficult to effectively attach an electronic sensor to is battery packs used with cordless tools, which come in a variety of different sizes and configurations. EAS stickers can be too easily removed from such items, and devices that effectively deter theft can be difficult to both attach and remove once the item is purchased.

### SUMMARY

The anti-theft device of the present application is easy to apply to a product, for example a battery, deters theft by being difficult to remove in-store, and is readily removed by a consumer after the product has been purchased. In addition, the anti-theft device can be used to accommodate a variety of size products, for example to fit different types of batteries. The anti-theft device includes a housing for receiving a portion of the product therein, a strap to secure the housing to the product, a locking assembly to deter removal of the anti-theft device, and a detachment portion to affect removal of the anti-theft device.

The locking assembly includes at least a first portion and at least a second portion which engage each other in a locked position to secure the housing to the product. In one embodiment, the locking assembly includes at least one locking tab supported on either the strap or the housing, the at least one locking tab engaging at least one corresponding opening and locking collar supported on the other of the strap or housing during use. In one embodiment, the at least one corresponding locking collar surrounds the opening and is designed to flex in a first direction as a head of the corresponding locking tab is inserted through the opening, and to lock into engagement with the head to prevent removal of the anti-theft device from the product. The head is supported on a shaft of the locking tab and includes a base that tapers to a tip to facilitate insertion into the corresponding locking collar. The base is broader than the tip of the head and acts as a stop to prevent unauthorized removal of the at least one locking tab from the corresponding locking collar.

The detachment portion, when cut, enables removal of the anti-theft device. In one embodiment, the detachment portion includes at least one groove or ridge positioned below the head of the locking tab on the shaft. The at least one ridge is sized to provide a sufficient distance between the top of the locking collar and the base of the locking tab to insert a cutting device, for example scissors, there between. Cutting the locking tab at the at least one ridge severs the head of the locking member from the locking tab and allows removal of the locking tab from the corresponding locking collar, thus allowing the device to be removed from engagement with the product. In another embodiment, the detachment portion is formed as a tab extending from housing and includes a channel extending into an opening in housing. In this embodiment, when the tab is cut it allows the circumference of the opening in the housing to be expanded and the housing to be removed from engagement with the product. In another embodiment, the detachment portion includes a channel formed in the housing and positioned under the strap so that a convention cutting instrument, for example scissors, can be readily positioned to cut the strap after it has been secured around the product.

To attach the anti-theft device to the product, the housing is positioned on the product and a portion of the product is received within an opening in the housing. The locking strap is then placed around the product and secured to the housing by the locking assembly. In one embodiment, to secure the locking assembly the one or more locking tabs of the anti-theft device are aligned with the corresponding locking openings and collars, and inserted therein. In another embodiment, an adjustable strap is provided and is placed around the product and adjustably secured to the housing by the locking assembly. The strap is disposed about a portion of the product and one end of the strap is inserted into a head supported on the other end of the strap in order to secure the strap. The fit of the strap is then adjusted around the product by pulling on the strap so that teeth formed in the strap engage the ratchet supported by the head to tighten and lock the strap around the product in an irreversible manner so that the strap cannot be pulled back and loosened.

To remove the anti-theft device, the consumer cuts through the detachment portion, allowing the device to be removed from engagement with the product.

The embodiments of the anti-theft device described herein can readily be used with a variety of products, is tamper resistant by being difficult to remove in-store, and is readily removed by a consumer after the product has been purchased, without damaging the product. The features of the anti-theft device as described herein may be adapted and used with a variety of batteries, and other products, where attachment by a strap may be utilized.

### BRIEF DESCRIPTION OF THE DRAWINGS

The foregoing and other objects, features and advantages will be apparent from the following description of exemplary embodiments, as illustrated in the accompanying drawings in which like reference characters refer to the same parts throughout the different views. The drawings are not necessarily to scale, emphasis instead being placed upon illustrating the principles disclosed herein.

FIG. 1 is an exploded perspective view of a first embodiment of an anti-theft device including a strap according to the present disclosure;

FIG. 2 is top, perspective view of a housing of the anti-theft device of FIG. 1;

FIG. 3 is bottom, perspective view of a housing of the anti-theft device of FIG. 1 with the EAS sensor removed;

FIG. 4 is bottom, perspective view of a housing of the anti-theft device of FIG. 1 with the EAS sensor in place;

FIG. 5 is a bottom plan view of the anti-theft device of FIG. 4;

FIG. 6 is a cross-sectional view of the housing taken along lines 6-6 of FIG. 5;

FIG. 7 is a cross-sectional view of the housing taken along lines 7-7 of FIG. 5;

FIG. 8 is a perspective view of the strap of the anti-theft device of FIG. 1;

FIG. 9 is side view of the strap of FIG. 8;

FIG. 10 is top view of the strap of FIG. 8;

FIG. 11 is a cross-sectional view of the strap taken along lines 11-11 of FIG. 10;

FIG. 12 is a perspective view of the anti-theft device of FIG. 1 being attached to an exemplary battery in a first position;

FIG. 13 is a perspective view of the anti-theft device of FIG. 1 attached to an exemplary battery in a second position;

FIG. 14 is a cross-sectional view of the anti-theft device and product taken along lines 14-14 of FIG. 13;

FIG. 15 is an enlarged, cross-sectional view of the locking assembly of the anti-theft device of FIG. 14;

FIG. 16 is top, perspective view of a housing of a second embodiment of an anti-theft device according to the present disclosure;

FIG. 17 is a bottom, perspective view of the anti-theft device including the housing according to FIG. 16;

FIG. 18 is a top plan view of the housing of FIG. 16;

FIG. 19 is a perspective view of the anti-theft device of FIG. 17 attached to an exemplary battery;

FIG. 20 is a bottom, perspective view of a third embodiment of an anti-theft device according to the present disclosure;

FIG. 21 is a top plan view of the housing of the anti-theft device of FIG. 20;

FIG. 22 is a perspective view of the housing of the anti-theft device of FIG. 20;

FIG. 23 is a perspective view of the anti-theft device of FIG. 20 attached to an exemplary battery;

FIG. 24 is a perspective view of the anti-theft device of FIG. 20 during severing of the detachment portion;

FIG. 25 is a perspective view of the anti-theft device of FIG. 20 being removed from the product;

FIG. 26 is a perspective view of a fourth embodiment of an anti-theft device according to the present disclosure during attachment to an exemplary battery;

FIG. 27 is a cross-sectional view of the anti-theft device of FIG. 26 and a phantom view of the strap during use;

FIG. 28 is a perspective view of the anti-theft device of FIG. 26 attached to an exemplary battery;

FIG. 29 is a top plan view of the anti-theft device of FIG. 26

FIG. 30 is an exploded perspective view of a fifth embodiment of an anti-theft device including a strap according to the present disclosure;

FIG. 31 is a perspective view of the anti-theft device of FIG. 30 attached to an exemplary battery;

FIG. 32 is a perspective view of a sixth embodiment of an anti-theft device according to the present disclosure for attachment to an exemplary battery;

FIG. 33 is a top plan view of the housing of the anti-theft device including a strap of FIG. 32;

FIG. 34 is a perspective view of the housing of the anti-theft device including a strap of FIG. 32;

FIG. 35 is a perspective view of the anti-theft device of FIG. 32 attached to the exemplary battery; and

FIG. 36 is a cross-sectional view of the anti-theft device of FIG. 32, taken along lines 36-36 of FIG. 35.

### DETAILED DESCRIPTION OF THE ILLUSTRATIVE EMBODIMENTS

The embodiments disclosed herein relate to an anti-theft device including a strap for securing the anti-theft device to a product. As used herein, the term “product” refers to any item that may benefit from an anti-theft device including a strap. Although the exemplary embodiments describe herein all refer to a battery pack as the product, such as may be used with a cordless tool, the disclosure is specifically not limited thereto. As also used herein, the term “electronic article surveillance” (EAS) tag, sensor, label or marker refers to any conventionally available article surveillance sensor that triggers an alarm if not detached or disarmed before the product is removed from a designated area, such as a store, as is known in the art. Although referred to as “electronic”, EAS sensors as used herein include and sensor that triggers an alarm if not deactivated, disarmed, or removed, including, but not limited to conventional electronic sensors such as acousto-magnetic (A/M) sensors, magnetic sensors, radio-frequency (RF) sensors, and the like, as would be known to those of skill in the art.

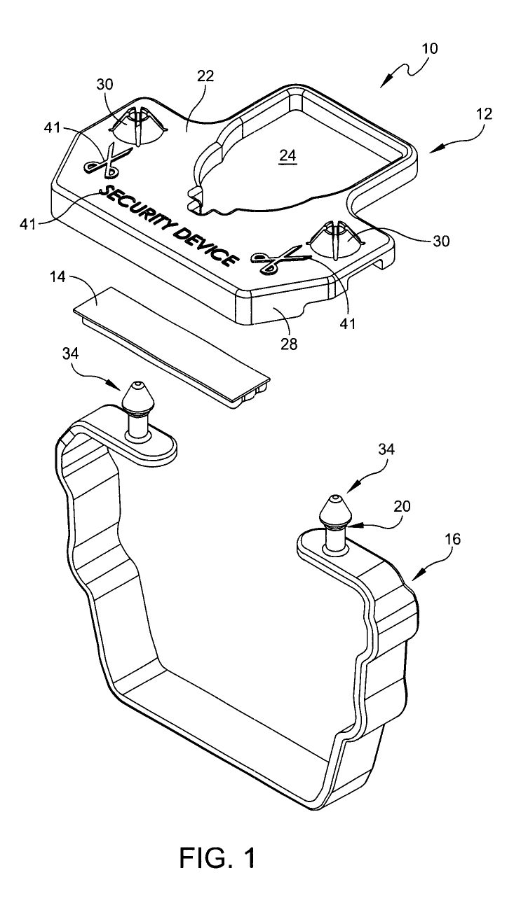

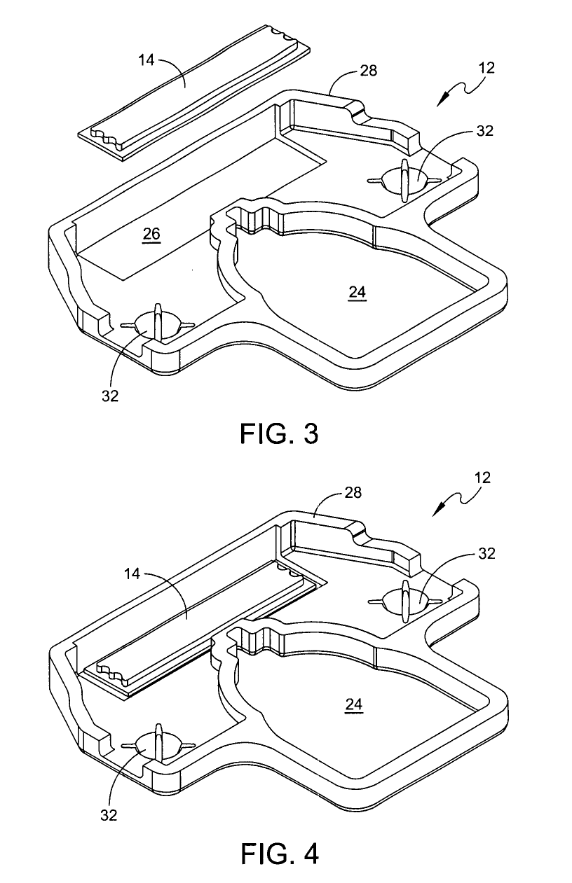

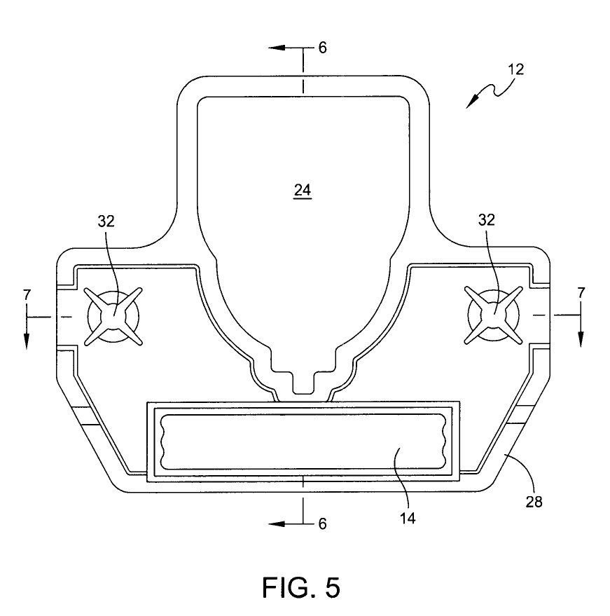

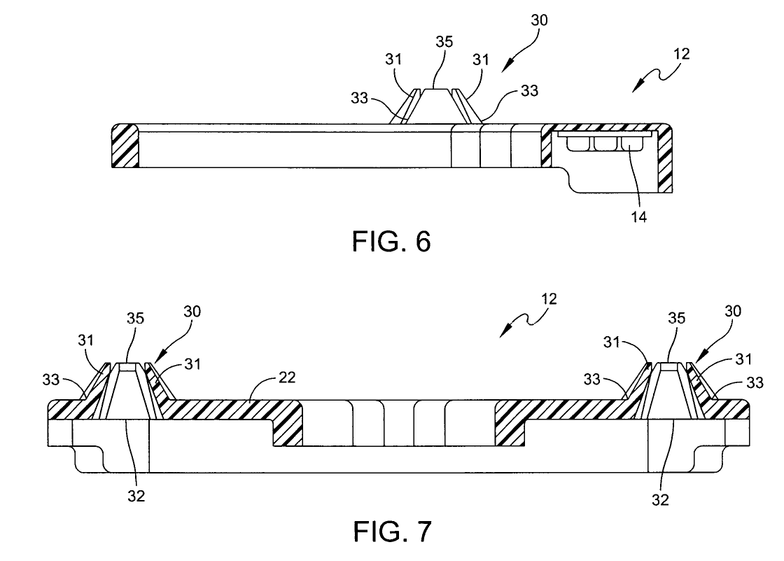

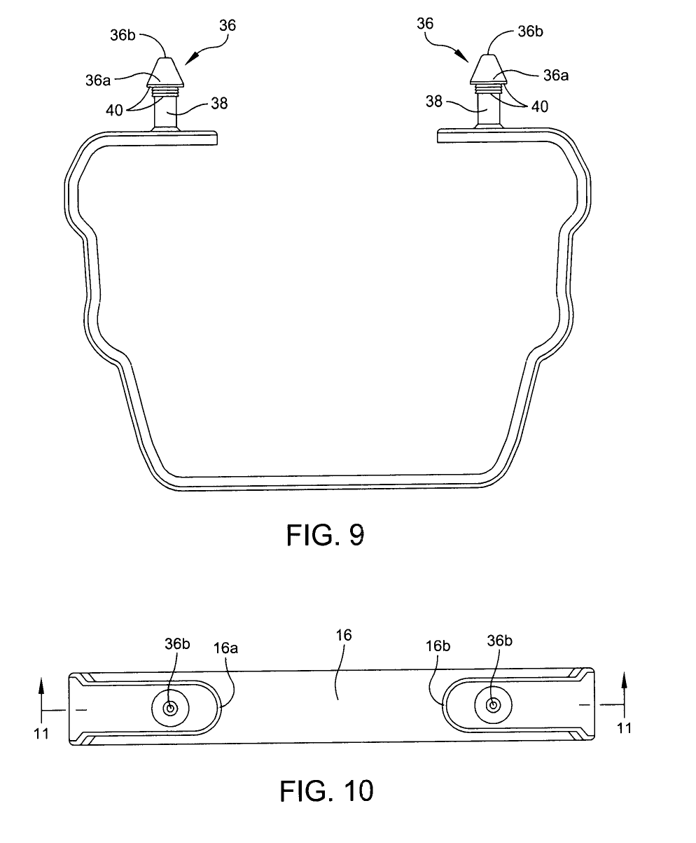

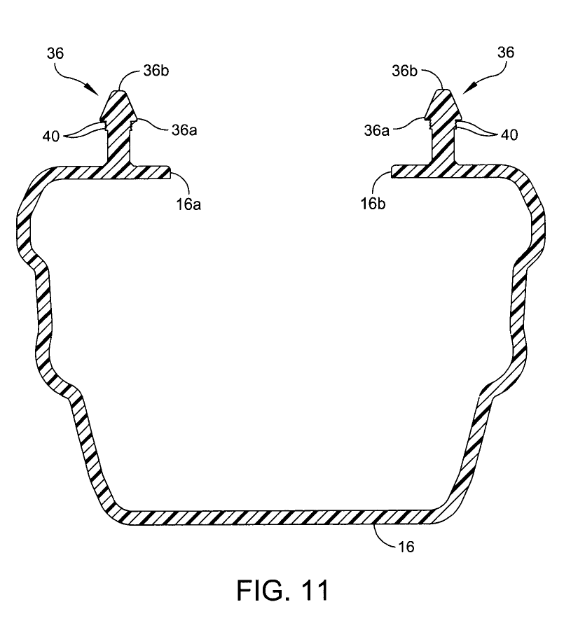

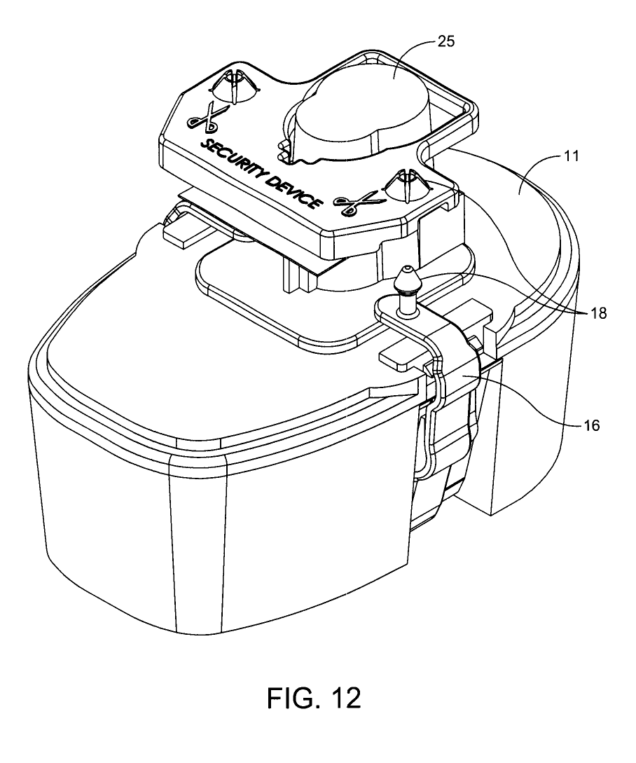

Referring initially to FIGS. 1-12, an exemplary first embodiment of an anti-theft device 10 used to deter theft of a product 11, for example a battery pack, is illustrated. The anti-theft device 10 includes a housing 12 that can support an EAS sensor 14, a strap 16 to secure the housing 12 to the product 11, a locking assembly 18 to deter removal of the anti-theft device, and a detachment portion 20 to affect removal of the anti-theft device 10.

Housing 12 preferably includes body 22, an opening 24 disposed through body 22 for receiving a portion of the product 11 there through, and a surface, for example recessed cavity 26 for supporting EAS sensor 14. Although an EAS sensor is illustrated as supported by the housing, the anti-theft sensor 14 may be supported on other parts of the device, for example on the strap 16, between the strap 16 and the product 11. Alternatively, the EAS sensor may be omitted altogether. Opening 24 is shaped and sized to receive a portion of the product 11 there through, for example battery cap 25 in the present embodiment. Housing 12 may also include a wall 28 that rests on the product during use. Housing 12 in the present embodiment also supports a portion of the locking assembly 18.

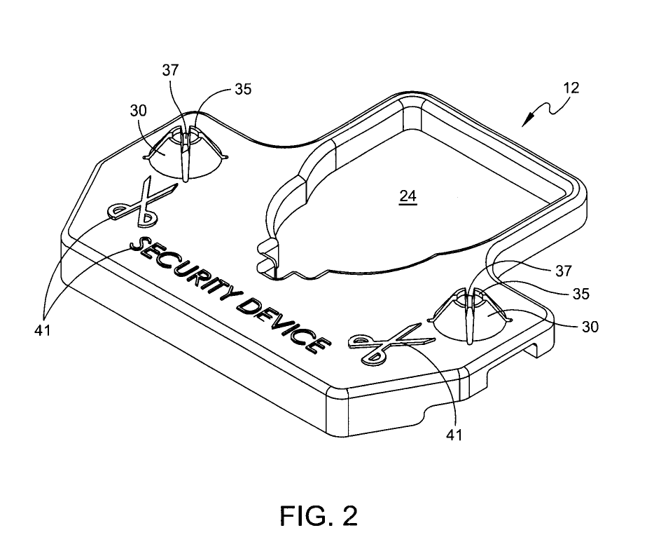

Locking assembly 18 includes at least a first portion supported on the housing and at least a second portion supported on the strap, the first and second portions engaging each other during use in order to secure the strap 16 to housing 12. As illustrated in FIG. 7, in the present embodiment locking assembly 18 includes at least one opening 32 formed in housing 12, and a corresponding locking collar 30 disposed around the at least one opening 32. The locking collar 30 may include a plurality of flexible fingers 31 which allow the locking collar 30 to flex and expand during insertion of a corresponding locking tab 34. The flexible fingers 31 are supported at their base 33 on housing 12 and are angled so as to taper toward each other at the top surface 35 of the collar 30. An opening 37 (FIG. 2) is defined at the top surface 35 by the flexible fingers 31 so that a portion of the locking tab 32 can pass completely through the locking collar 30 during use.

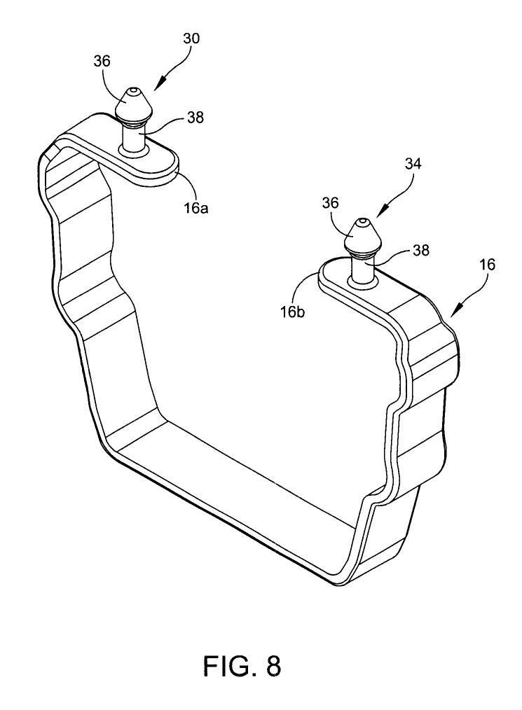

At least one locking tab 34 is provided as part of the locking assembly 18 for insertion into the at least one locking collar 30. In the present embodiment, the at least one locking tab 34 is supported on strap 16 (FIGS. 8-12) which has a length sized to wrap around a portion of battery 11 in order to secure the anti-theft device 10 to the battery. While the length of the strap 16 is sufficient to wrap around the battery 11, the fit should be sufficiently tight so as to not allow a consumer to tamper with the strap 16. Therefore, the shape of the strap 16 may also be selected to match the profile of the battery 11 to further hinder tampering. Strap 16 further includes a first end 16a and a second end 16b, opposite the first end. In the present embodiment, a first locking tab 34 is supported adjacent the first end 16a and a second locking tab 34 is supported adjacent the second end 16b of strap 16. Strap 16 preferably also has a thickness sufficient so as to not be readily breakable by a consumer in order to deter unauthorized detachment of the anti-theft device.

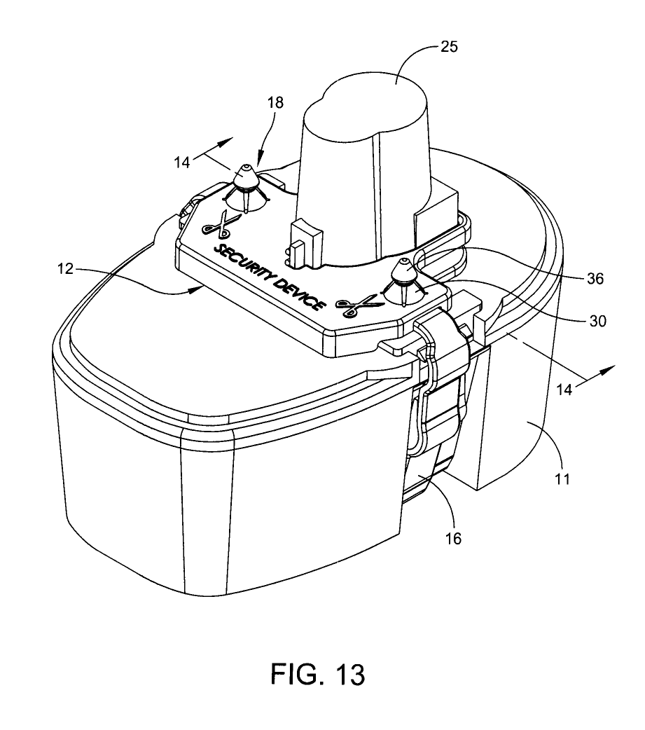

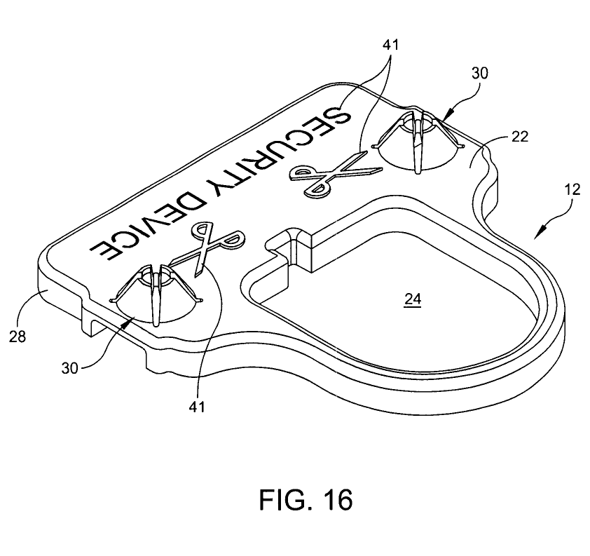

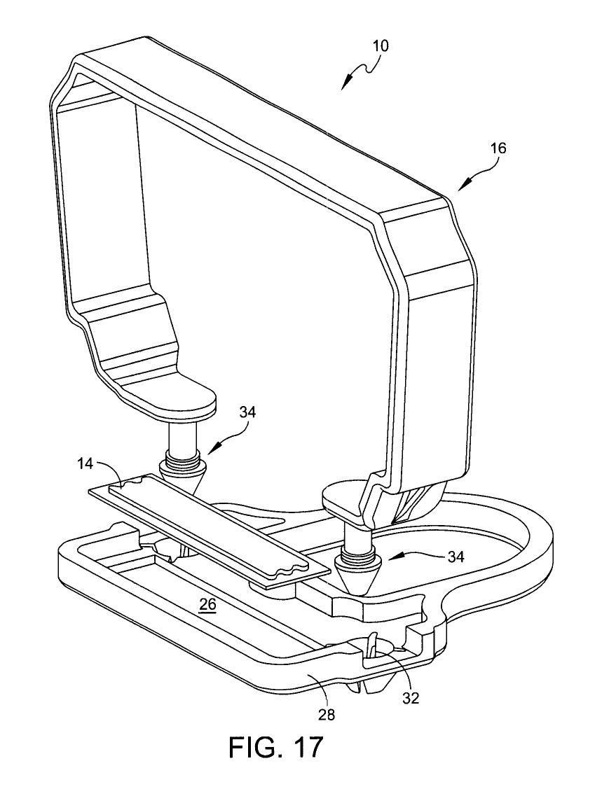

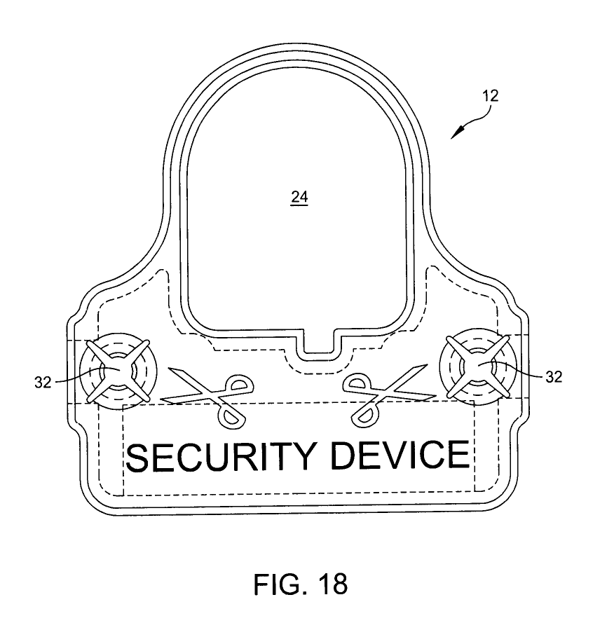

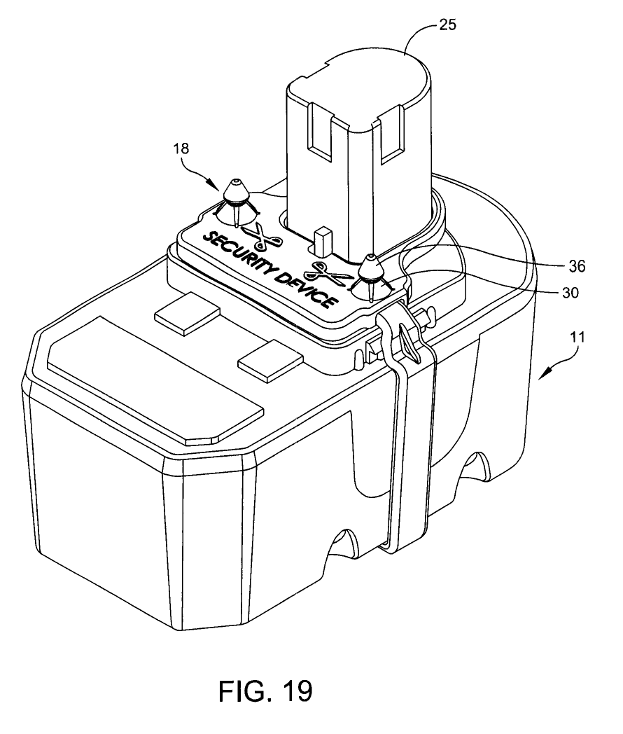

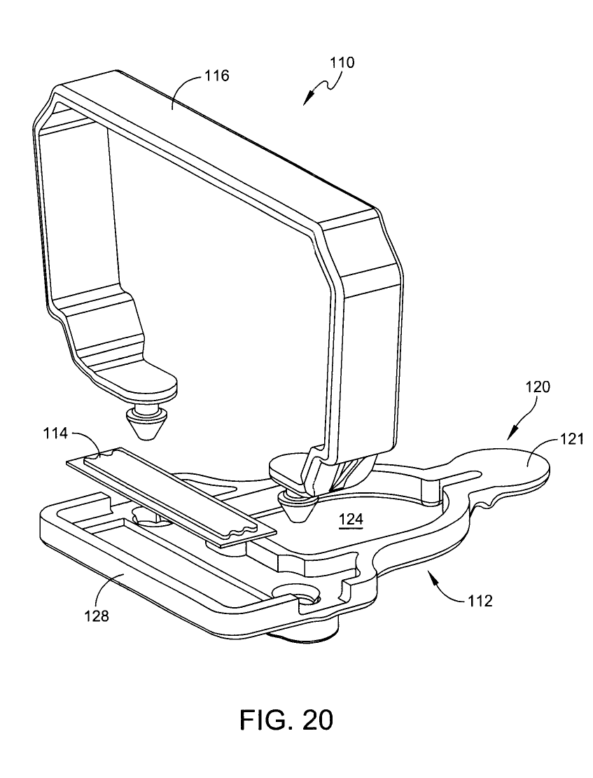

Referring now to FIGS. 16-19, an alternate embodiment of housing 12 and strap 16 is illustrated. In this embodiment, the housing 12 and strap 16 have a shape that is slightly different than the shape of the housing 12 and strap 16 of FIGS. 1-15 in order to accommodate a product 11 (FIG. 19) that has a different shape than the first embodiment. For example, the opening 24 is sized to receive the battery cap 25 of the product 11 in the present embodiment, and has a corresponding shape. Likewise, the profile of the strap 16 in the present embodiment has a shape corresponding to the profile of the battery 11 of FIG. 19. Other than minor differences to accommodate the different product shape and size, the anti-theft device 10 of FIGS. 16-19 functions the same as that of FIGS. 1-18, so the numbering has been kept the same between the two embodiments. As will be appreciated, any number of different shapes and sizes may be utilized for the housing and strap, depending upon the particular product shape and size. Therefore, the present application is not limited to a particular configuration for the housing and/or strap as it relates to shape and/or size.

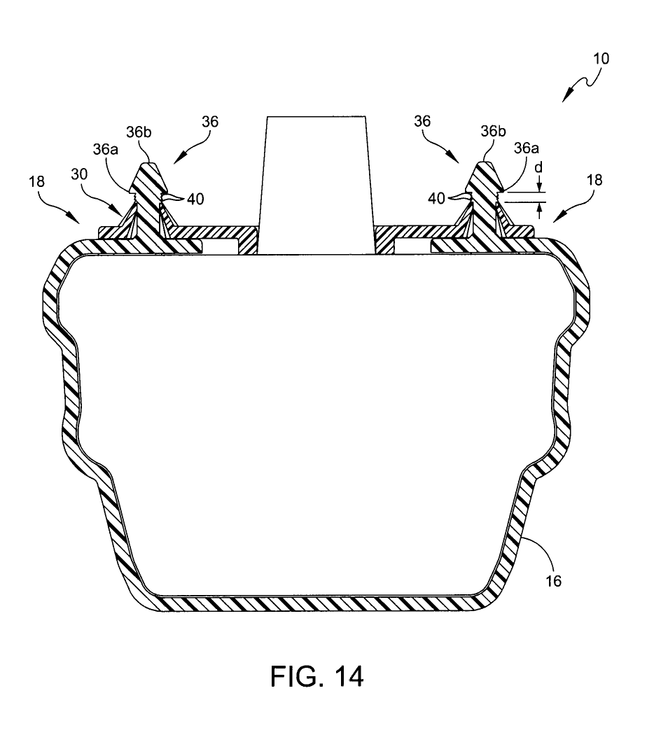

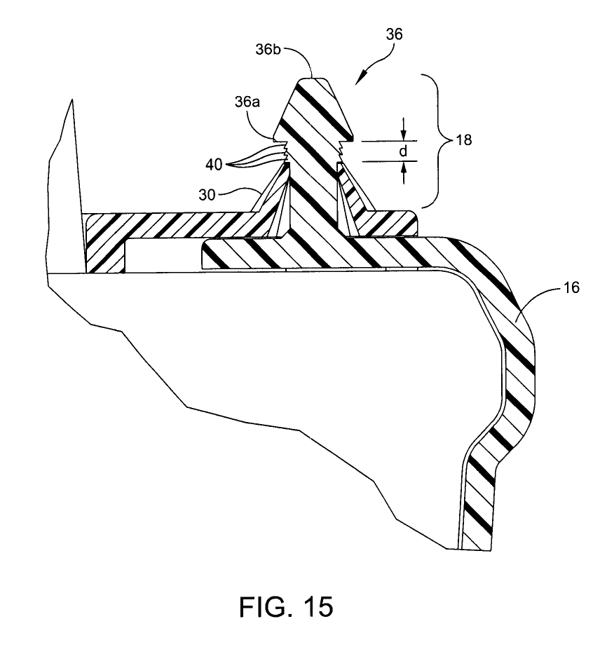

Referring now to FIGS. 14-15, each locking tab 34 includes a head 36 supported on a shaft 38, the head 36 having a base 36a that tapers to a tip 36b to facilitate insertion into the corresponding locking collar 30. The base 36a is broader than the tip 36b of the head 36 and acts as a stop to prevent unauthorized removal of the at least one locking tab 34 from the corresponding locking collar 30 during use. During use, the locking tab 34 is inserted through opening 32 causing the collar 30 to flex and expand as the head 36 engages the flexible fingers 31 from inside the locking collar 30. After the head 36 is through the locking collar 30, the flexible fingers retract, substantially returning to their original position. The base 36a of the head is prevented from passing through the opening 35 of collar 30 to unlock the anti-theft device, because the base 36a is wider than the opening 35. The collar 30 also will not flex as the head 36 moves in the direction opposite to insertion, once the head has passed through the collar. Alternatively, other locking assemblies 18 may be utilized, other than locking collar 30 and locking tab 34, as would be know to those of skill in the art. In order to remove the anti-theft device 10 from product 11, the detachment portion 20 is severed, i.e. cut.

The detachment portion 20, when cut, enables removal of the anti-theft device 10. In the present embodiment, the detachment portion 20 includes at least one groove or ridge 40 positioned below the head 36 of the locking tab 34 on the shaft 38. The at least one ridge 40 includes a plurality of ridges in the present embodiment, which are sized to provide a sufficient distance “d” between a top surface 35 of the locking collar and the base 36a of the head 36 to insert a cutting device, for example scissors, there between. Cutting the locking tab 34 at the at least one ridge 40 severs the head 36 of the locking tab from shaft 38 and allows removal of the locking tab 34 from the corresponding locking collar 30. This, in turn, allows the strap 16 to be removed as well as housing 12, thus allowing the anti-theft device 10 to be completely removed from engagement with product 11. A symbol 41 (FIGS. 1-2), such as a pair of scissors, and/or written instructions, may be provided to indicated to the consumer where to cut.

Use of the anti-theft device 10 will now be described with reference to FIGS. 1-19. To attach the anti-theft device to the battery, the housing 12 is positioned on the product 11 by placing a portion 25 of the product through opening 24 formed in the housing. Strap 16 is then placed around the product 11 and secured to the housing 12 by the locking assembly 18. To secure the strap 16 around product 11, the one or more locking tabs 34 are aligned with the corresponding openings 32 of locking collars 30, and are inserted therein. Upon insertion of the locking tabs 34, the locking collars 30 flex and expand as the head 36 of the locking tabs 34 engage the flexible fingers 31 of the locking collars 30. Once the head 36 has passed through the locking collar 30, the base 36a of the head 36 prevents removal of the head 36 by acting as a stop to prevent the head from passing back through the collar 30.

To remove the anti-theft device 10 after purchase, the consumer cuts through the detachment portion 20, in order to sever the head 36 from the shaft 38 of the locking tab 34, thus allowing the device to be removed from engagement with the product, as described above. In this manner, a consumer can easily remove the anti-theft device 10 after the product 11 is purchased. However, the device 10 remains difficult to remove while in a store without calling attention to the theft (for example by using scissors in-store to cut through the detachment section which may be noticed by store employees).

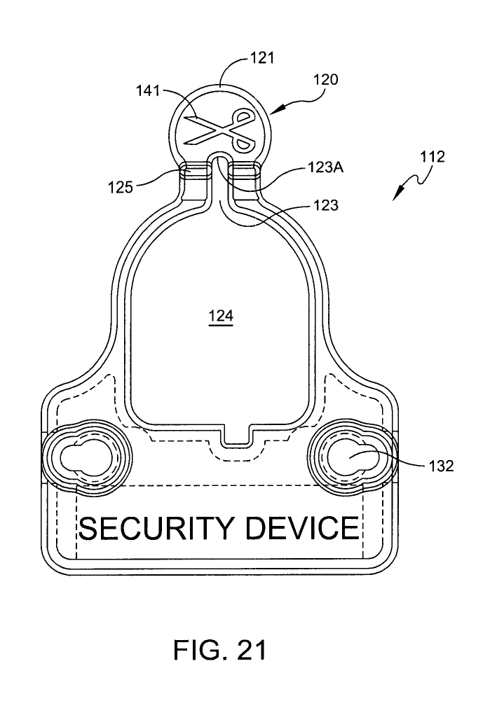

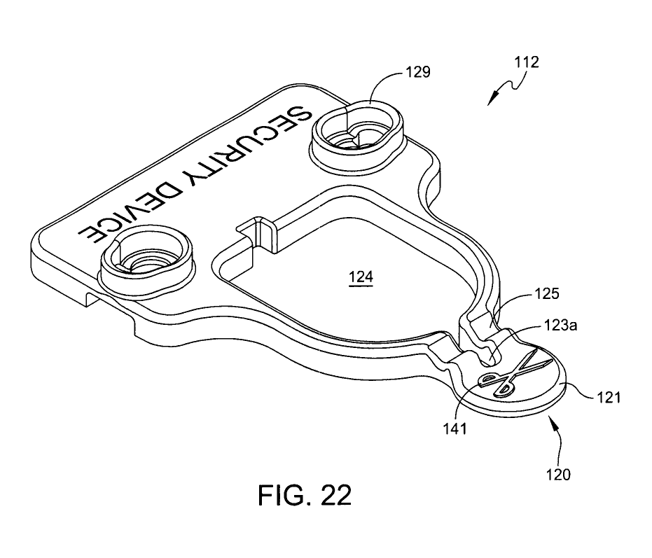

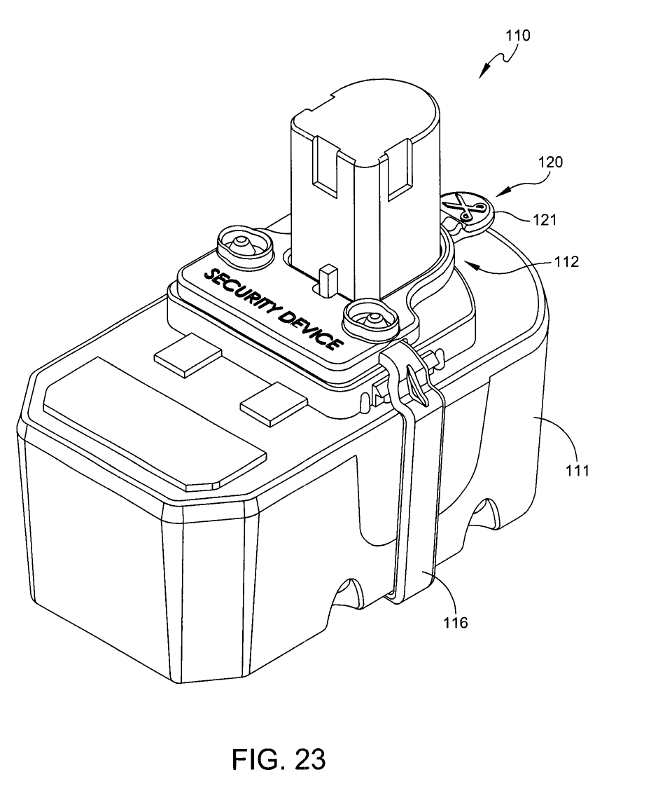

In another exemplary embodiment, the detachment portion is formed as a tab that is supported by the housing, as illustrated in FIGS. 21-25. In this embodiment, the same or similar as the embodiment of FIGS. 1-19 are labeled with the same reference numbers, preceded with the numeral “1”. As illustrated, detachment portion 120 is formed as a tab 121 that is supported by housing 112. The tab 121 includes a channel 123 that extends into opening 124 that receives a portion of product 111 therein, as described above with respect to the first embodiment. A first end 123a of the channel 123 is constrained by the detachment portion 120, while a second end 123b extends into opening 124. The tab 121 also includes an indentation or groove 125 to receive a cutting tool, such as a conventional pair of scissors 127. The thickness of groove 125 is preferably less than the housing 112, and also less than the tab 121. The reduced-thickness allows an average consumer to cut through the tab with a pair of conventional scissors. A symbol 141, such as a pair of scissors, and/or written instructions may be provided to indicated to the consumer where to cut.

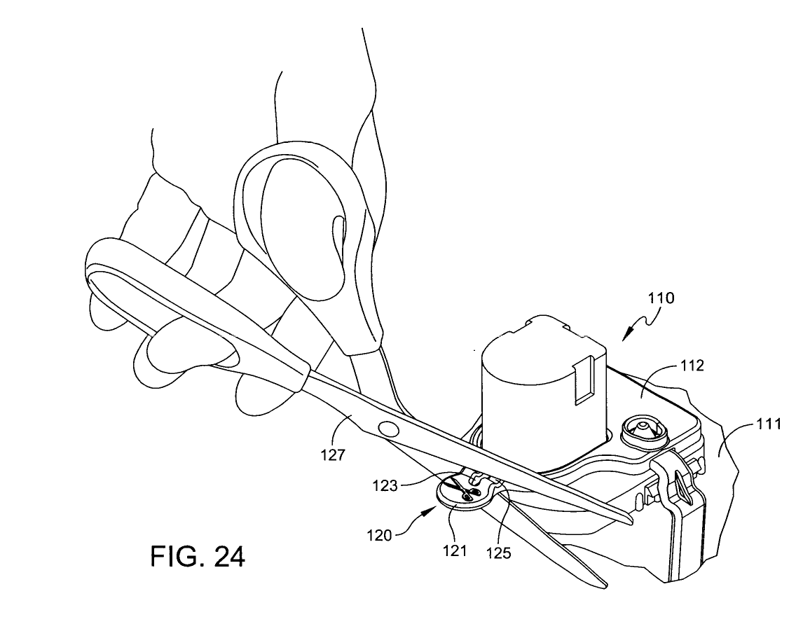

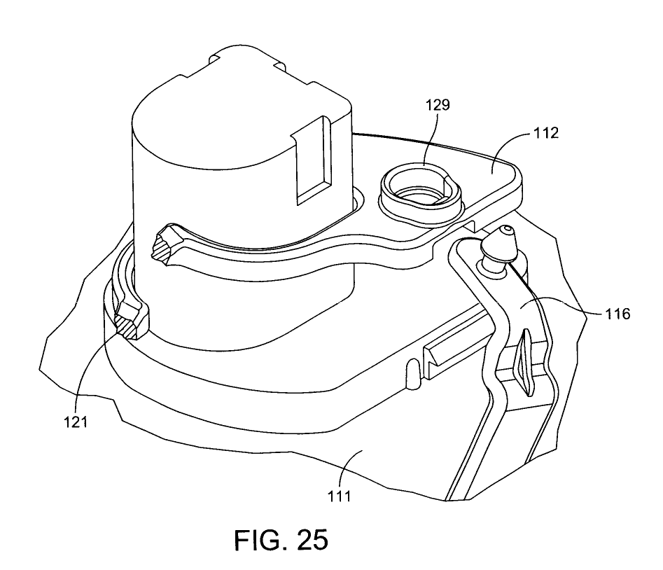

Referring now to FIGS. 24-25 the steps for removing the anti-theft device 110 from product 111 are illustrated (the steps of attachment being the same as described above with respect to the previous embodiments). The first step in removing the anti-theft device 110 is to cut through the groove 125 using a cutting instrument, for example a conventional pair of scissors 127, as shown. The scissors 127 are aligned with the groove 125 and sufficient pressure is applied to cut through the groove. Once the groove 125 has been cut, the channel 123 is no longer constrained at the first end 123a. The housing 112 can now be removed from the product 111 by twisting or pulling the housing 112, including any portion of the tab 121 that remains, in order to expand the housing opening 124 and remove the anti-theft device from engagement with the product 111. Once there is enough slack in the strap 116, the locking tab 134 can be readily removed from the corresponding opening 132 in the housing 112. More specifically, the present embodiment does not include a locking collar, but rather a collar 129 (FIG. 25) that acts as a barrier to prevent the use of a cutting device to sever the locking tab 134. Thus, during use each locking tab 134 is simply inserted within a corresponding opening 132 within the housing 112, through an enlarged opening 132a at one end, and slid over to a tapered opening 132 at the opposite end to hold the locking tab in place. Because there is not enough slack in strap 116, once attached a consumer cannot force the locking tabs back through openings 132 until the detachment portion 120 is cut.

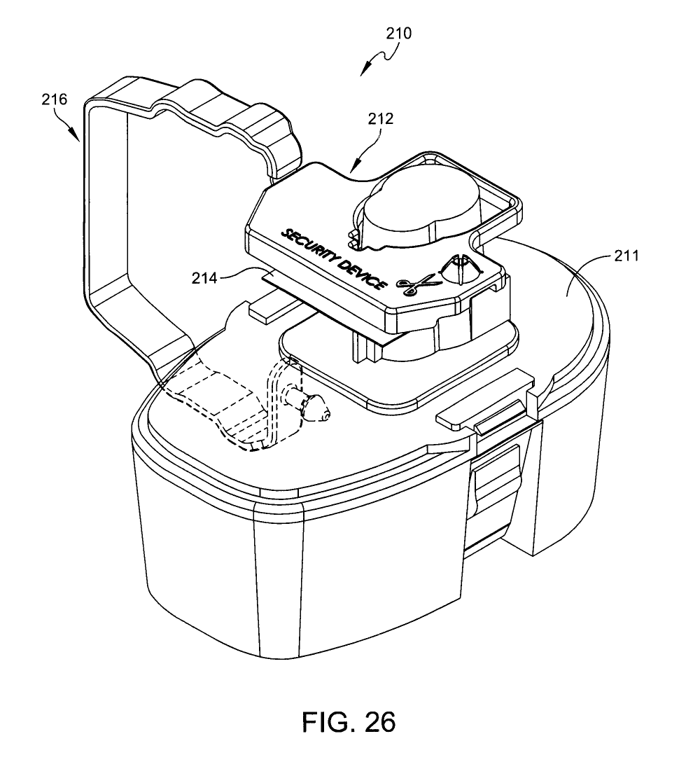

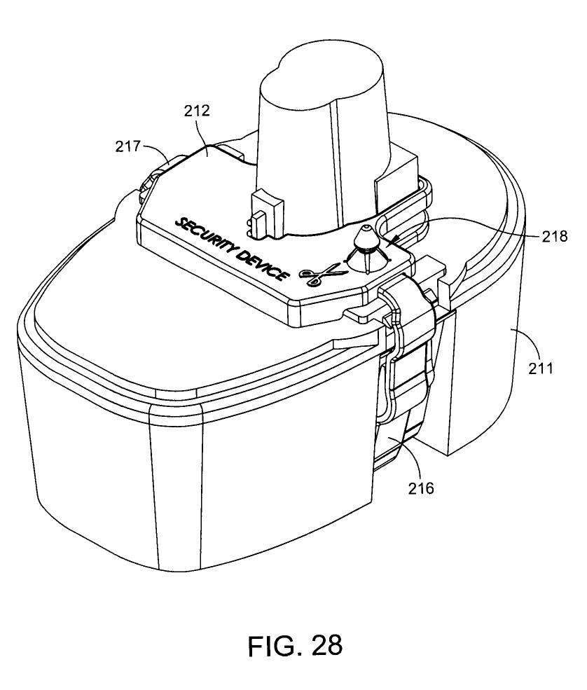

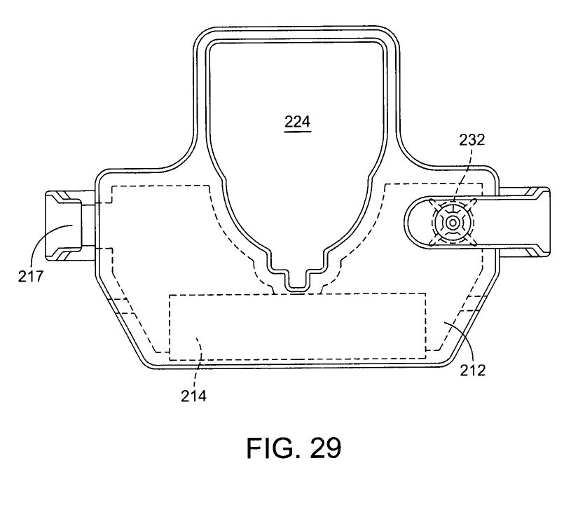

Referring now to FIGS. 26-29, a fourth exemplary embodiment of an anti-theft device including a strap is illustrated. In this embodiment, the same or similar elements as the previous embodiment are labeled with the same reference numbers, preceded with the numeral “2”. As illustrated, anti-theft device 210 also includes a housing 212 that can support an EAS sensor 214, a strap 216 to secure the housing 212 to the product 211, a locking assembly 218 to deter removal of the anti-theft device, and a detachment portion 220 to affect removal of the anti-theft device 210. However, in the present embodiment, the locking assembly 218 includes a single locking tab 234 for insertion into a corresponding opening 232 and locking collar 230. The at least one locking tab 234 is supported on one end 216b of strap 216, and the opposite end 216a of strap 216 includes a hinge 217 that is secured to housing 212.

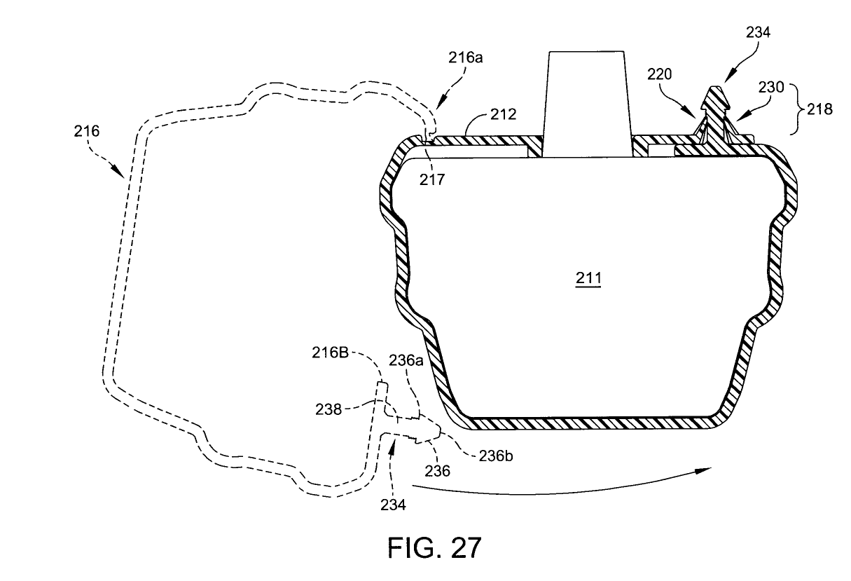

As best seen in FIG. 27, hinge 217 allows the strap 216 to move between an open position (shown in dotted lines) out of engagement with product 211, to a closed position where the locking tab 234 engages locking collar 230, and the strap 216 is secured around product 211. Other than the addition of hinge 217 in place of one of the locking tabs 234, opening 232, and locking collar 230, the anti-theft device has the same construction as the device of FIGS. 1-15. For example, locking tab 234 also includes a head 236 supported on a shaft 238, the head 236 having a base 236a that tapers to a tip 236b to facilitate insertion into the corresponding locking collar 230. The base 236a is broader than the tip 236b of the head 236 and acts as a stop to prevent unauthorized removal of the at least one locking tab 234 from the corresponding locking collar 230 during use.

To attach the anti-theft device to the product, the housing 212 is positioned on the product 211 by placing a portion of the product through opening 224 formed in the housing. Hinge 217 is supported by housing 212 at one end 216a of strap 216, and the strap is moved from an open position out of engagement with the product, is placed around the product 211 and secured at its other end 216b to the housing 212 by the locking assembly 218 into a closed position. To secure the strap 216 around product 211, the locking tab 234 is aligned with the corresponding opening 232 and locking collar 230, and is inserted therein. Upon insertion of the locking tab 234, the locking collar 230 flexes and expands as the head 236 of the locking tab engages the flexible fingers 231 of the locking collar 230. Once the head 236 has passed through the locking collar 230, the base 236a of the head 236 prevents removal of the head 236 by acting as a stop to prevent the head from passing back through the collar 230, as described above. To remove the anti-theft device after purchase, the consumer cuts through the detachment portion 220, in order to sever the head 236 from the shaft 238 of the locking tab 234, thus allowing the strap to be removed from around the product 211 and the housing 212 to also be removed. In this manner, a consumer can easily remove the anti-theft device 210 after the product 211 is purchased. However, the device 210 remains difficult to remove while in a store without calling attention to the theft (for example by using scissors in-store to cut through the detachment section which may be noticed by store employees).

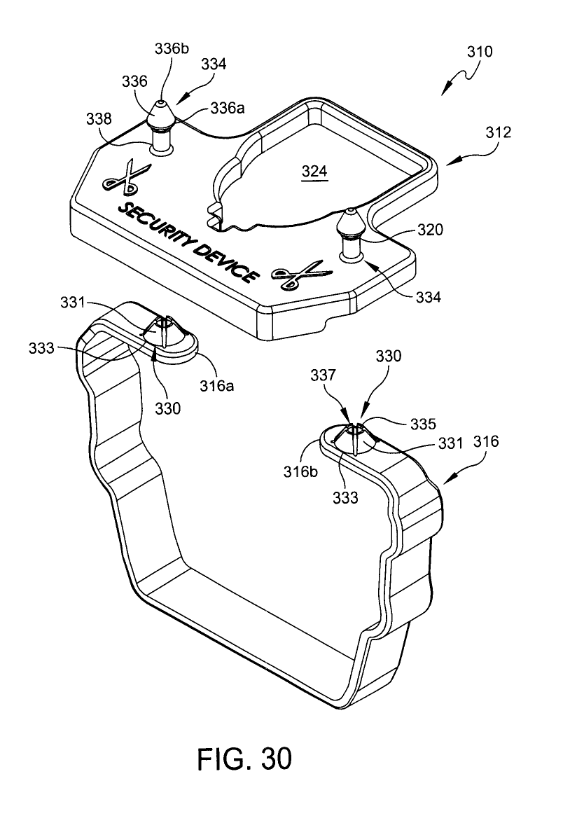

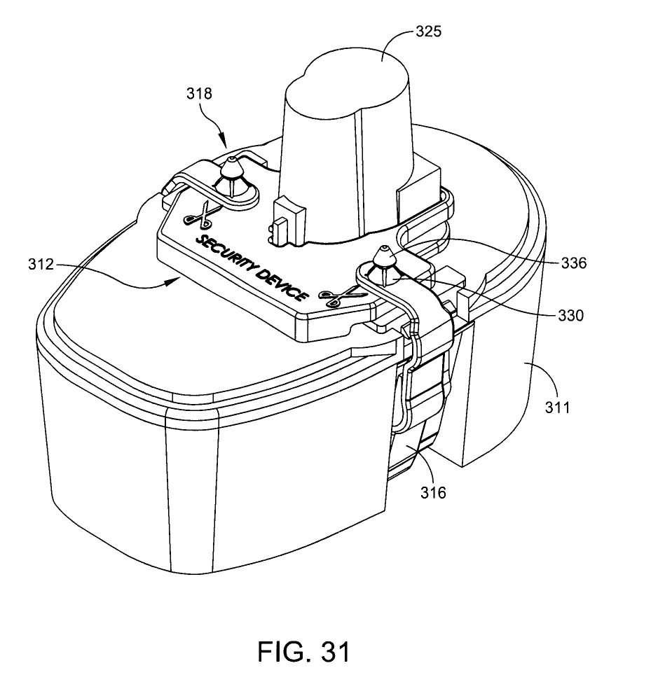

Referring now to FIGS. 30-31, a fifth exemplary embodiment of an anti-theft device including a strap is illustrated. In this embodiment, the same or similar elements as the previous embodiment are labeled with the same reference numbers, preceded with the numeral “3”. As illustrated, anti-theft device 310 also includes a housing 312 that can support an EAS sensor, a strap 316 to secure the housing 312 to the product 311, a locking assembly 318 to deter removal of the anti-theft device, and a detachment portion 320 to affect removal of the anti-theft device 310. However, in the present embodiment, the parts of the locking assembly 318 are reversed, i.e. the at least one locking collar 330 and corresponding openings 332 are supported on the strap 316, while the at least one locking tab 334 is supported on the housing.

Other than reversing the parts of the locking assembly 318, the anti-theft device has the same construction as the device of FIGS. 1-15. For example, locking tab 334 also includes a head 336 supported on a shaft 338, the head 336 having a base 336a that tapers to a tip 336b to facilitate insertion into the corresponding locking collar 330 supported on either end 316a, 316b of the strap 316. The base 336a is broader than the tip 336b of the head 336 and acts as a stop to prevent unauthorized removal of the at least one locking tab 334 from the corresponding locking collar 330 during use, as described above. Likewise, the locking collar 330 is disposed around openings 332 formed either end 316a, 316b of the strap 316 and may include a plurality of flexible fingers 331 which allow the locking collar 330 to flex and expand during insertion of a corresponding locking tab 334, as also described above. The flexible fingers 331 are supported at their base 333 on strap 316 and are angled so as to taper toward each other at the top surface 335 of the collar 330. An opening 337 is defined at the top surface 335 by the flexible fingers 331 so that a portion of the locking tab 332 can pass completely through the locking collar 330 during use.

To attach the anti-theft device to the product, the housing 312 is positioned on the product 311 by placing a portion of the product 325 through opening 324 formed in the housing, as also described above. Strap 316 is then placed around the product 311 and secured to the housing 312 by the locking assembly 318. To secure the strap 316, the one or more openings 332 and locking collars 330 supported on strap 316 are aligned with the corresponding locking tabs 334 supported on the housing 312 and the locking tabs 334 are inserted therein. Upon insertion of the locking tabs 334, the locking collars 330 flex and expand as the head 336 of the locking tabs 334 engage the flexible fingers 331 of the locking collars 330. Once the head 336 has passed through the locking collar 330, the base 336a of the head 336 prevents removal of the head 336 by acting as a stop to prevent the head from passing back through the collar 330.

As also described above, to remove the anti-theft device after purchase, the consumer cuts through the detachment portion 320, in order to sever the head 336 from the shaft 338 of the locking tab 334 thus allowing the device to be removed from engagement with the product, as described above. In this manner, a consumer can easily remove the anti-theft device 310 after the product 311 is purchased. However, the device 310 remains difficult to remove while in a store without calling attention to the theft.

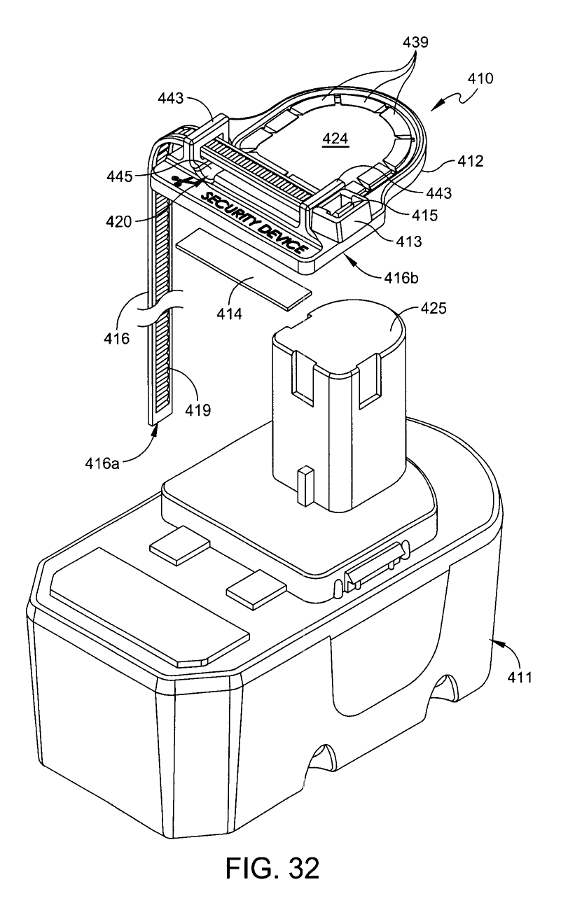

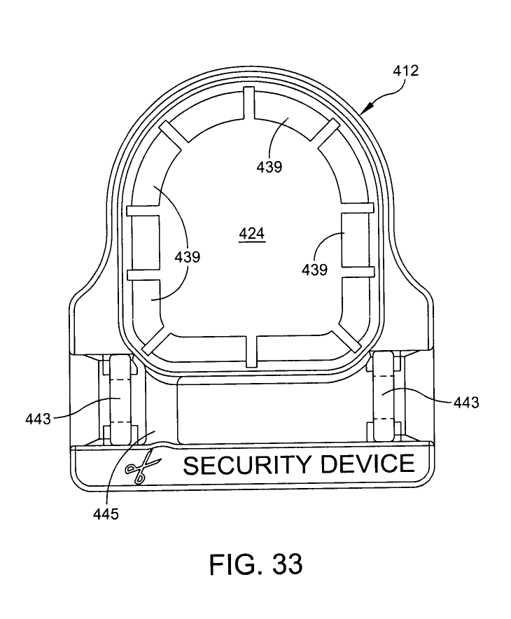

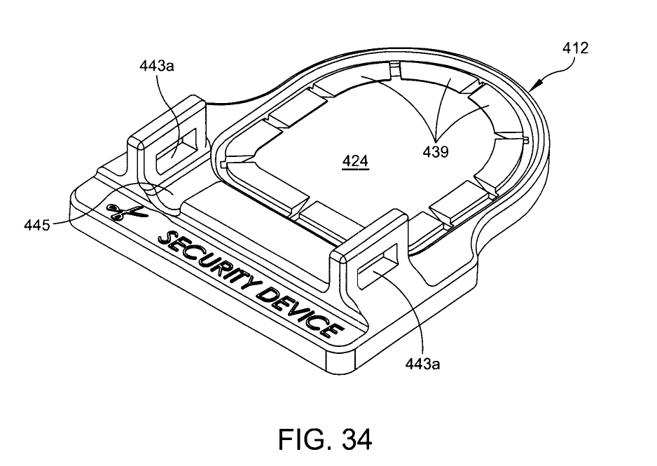

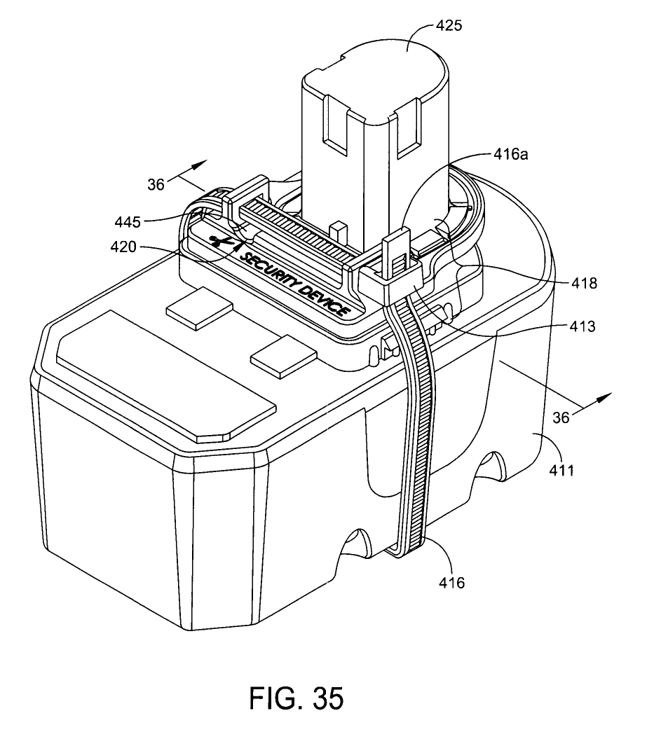

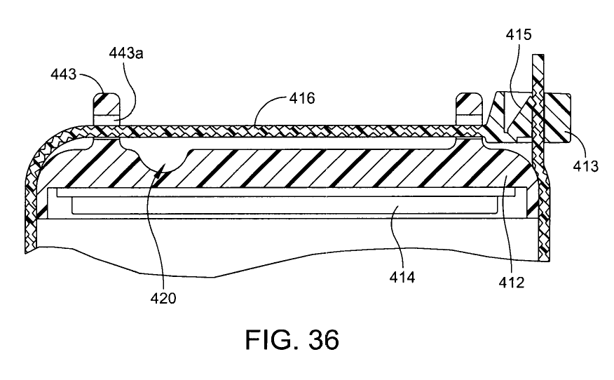

A sixth exemplary embodiment of an anti-theft device including a strap is illustrated in FIGS. 32-35. In this embodiment, the same or similar elements as the previous embodiment are labeled with the same reference numbers, preceded with the numeral “4”. Anti-theft device 410 also includes a housing 412 that can support an EAS sensor 414, a strap 416 to secure the housing 412 to the product 411, a locking assembly 418 to deter removal of the anti-theft device, and a detachment portion 420 to affect removal of the anti-theft device 410. However, in the present embodiment, the strap 416 is an adjustable strap.

Strap 416 includes a first end 416a, or tail, which is insertable into a head 413 that is supported on the second end 416b of the strap. The strap 416 is received within at least one holder 443 supported on housing 412, so that the strap can be wrapped around a portion of the product 411 and the tail 416a can be readily inserted within the head 413 and adjusted therein. In the present embodiment a pair of holders 443 are provided that include openings 443a large enough to receive the tail 416a and the strap 416 there through, but small enough to prevent head 413 from passing there through, although other methods of supporting the strap on the housing may be utilized, as would be known to those of skill in the art.

The strap 416 also includes a plurality of teeth 419 that engage a ratchet 415 supported by the head 413. In the present embodiment, the teeth and the ratchet make up the locking assembly 418. The ratchet allows the strap to be adjusted as it is locked around the product 411 so that the strap can be tightened around the product, but not loosened, i.e. the strap 416 can only be moved in one direction within the head 413, to tighten the strap. Thus, each pull of the strap 416 tightens the strap around the product 411 in an irreversible manner so that the strap 416 cannot be pulled back and loosened. By utilizing an adjustable strap, the anti-theft device 410 can be readily used with a variety of differently shaped and sized products 411. In addition to the adjustable strap 416, the anti-theft device may also include a plurality of flexible fingers 439 disposed around the perimeter of opening 424.

Flexible fingers 439 also allow the anti-theft device 410 to be used with products having a variety of shapes and sizes. The flexible fingers 439 allow the opening 424 of the housing 412 to receive a portion of product 411, for example battery cap 425, without customizing the shape of the opening 424 to the particular shape of the product being received therein. In this manner, the fingers 439 engage the product 411 to provide a secure fit, without the opening 424 having the exact shape of the product received therein. The opening 424 should preferably be large enough to receive the portion of product 411 therein, and the portion of the product 411 received within the opening should preferably contact flexible fingers 439.

A detachment portion 420 is also provided in order to remove the anti-theft device 410 from product 411. In the present embodiment, a channel 445 is formed in housing 412 and positioned under strap 416 so that a convention cutting instrument, for example scissors, can be readily positioned to cut the strap 416 after it has been tightened around product 411. The channel 445 and the portion of the strap 416 adjacent the channel form the detachment portion in the present embodiment. Alternatively, other types of detachment portions may be provided, as would be know to those of skill in the art.

Use of the anti-theft device 410 will now be described with reference to FIGS. 32-35. Housing 412 is positioned on the product 411 by inserting a portion 425 of the product through opening 424 formed in the housing. As the opening 424 receives the portion 425 of product 411, flexible fingers contact the portion 425 of the product and flex in order to receive the product and provide a secure fit of the product within the opening 424. Adjustable strap 416 is supported on housing 412 by inserting the strap within at least one holder 443 such that the head 413 of the strap is adjacent the at least one holder 443. The holder 443 acts to hold and guide strap 416, and also acts as a stop to prevent the head 413 from being pulled through the at least one holder 443.

The adjustable strap 416 is then placed around the product 411 and adjustably secured to the housing 412 by the locking assembly 418. The strap 416 is disposed about a portion of the product 411 and the tail 416a is inserted into a head 413 in order to secure the strap 416. The fit of the strap 416 is then adjusted around the product 411 by pulling on the strap 416 so that the teeth 419 of the strap 416 engage the ratchet 415 supported by the head 413 to tighten and lock the strap 416 around the product 411 in an irreversible manner so that the strap 416 cannot be pulled back and loosened.

To remove the anti-theft device after purchase, the consumer inserts a cutting instrument into channel 445 and cuts through the portion of the strap 416 adjacent the channel in order to sever the strap 416. Once the strap 416 is severed, the strap can be removed and the housing 412 can be removed from engagement with the product 411. In this manner, a consumer can easily remove the anti-theft device 410 after the product 411 is purchased. However, the device 410 remains difficult to remove while in a store without calling attention to the theft.

It will be understood by those skilled in the art that various changes in form and details may be made herein without departing from the spirit and scope of the invention as defined by the appended claims. For example, the materials disclosed herein may be readily changed, as may the dimensions and geometric configurations. Also, the method of severing the tag may be different than the exemplary methods described herein. Likewise, the collar and locking tabs may also be modified. The exemplary products may also vary widely including, but not limited to those illustrated herein. For example, although a battery pack for a cordless tool is illustrated as the product, the present anti-theft device may be utilized with a variety of other products. In addition, the type, use and placement of the EAS sensor may also be varied, depending upon the particular application. Therefore, the above description should not be construed as limiting, but merely as exemplifications of preferred embodiments. Those skilled in the art will envision other modifications within the scope, spirit and intent of the invention.

What is claimed is:

1. An anti-theft device for use with a product comprising:
a housing including an opening configured and dimensioned to receive a portion of the product therein;
a strap including a first end and a second end opposite the first end, the strap being sized to fit around a portion of an outer surface of the product and constructed and arranged to secure the housing to the product;
a locking assembly including at least a first portion and at least a second portion, the first and second portions engaging each other in a locked position to deter removal of the anti-theft device; and
a detachment portion constructed and arranged to be severed by a consumer;
wherein to remove the anti-theft device from engagement with the product, at least a portion of the detachment portion is severed and the strap and the housing are removed from engagement with the product.

2. The anti-theft device of claim 1, wherein the locking assembly includes at least one locking tab, at least one opening configured and dimensioned to receive the at least one locking tab, and at least one collar disposed around the at least one opening.

3. The anti-theft device of claim 2, wherein the at least one collar is a locking collar.

4. The anti-theft device of claim 3, wherein the locking collar includes plurality of flexible fingers disposed about the perimeter of the at least one opening, the fingers flexing upon insertion of the locking tab in order to receive the locking tab therein, and retracting after the locking tab passes there through to prevent withdrawal of the locking tab.

5. The anti-theft device of claim 2, wherein the at least one locking tab is supported on the strap, the at least one opening is disposed in the housing, and the at least one collar is supported on the housing.

6. The anti-theft device of claim 5, wherein the at least one locking tab includes a first locking tab supported adjacent the first end of the strap and a second locking tab supported adjacent the second end of the strap.

7. The anti-theft device of claim 2, wherein the at least one locking tab is supported on the housing, the at least one opening is disposed in the strap, and the at least one collar is supported on the strap.

8. The anti-theft device of claim 2, wherein each of the at least one locking tabs includes a head supported on a shaft, the head including a base that has is wider than the tip, the tip facilitating insertion through the at least one opening and the at least one collar, and the base constructed and arranged to act as a stop to prevent removal of the locking tab from the at least one collar once inserted there through.

9. The anti-theft device of claim 8, wherein the detachment portion includes at least one ridge disposed below the head of the locking tab on the shaft, the ridge being constructed and arranged to provide a sufficient distance between a top surface of the at least one locking collar and the base of the bead of the at least one locking tab to insert a cutting device.

10. The anti-theft device of claim 1, wherein the detachment portion includes a groove having a thickness less than that of the housing, the groove being constructed and arranged to receive the cutting tool therein.

11. The anti-theft device of claim 2, wherein the detachment portion includes a tab supported by the housing, a channel that extends into the opening in the housing, and a groove having a thickness less than that of the housing, the groove being constructed and arranged to receive the cutting tool therein.

12. The anti-theft device of claim 1, further comprising a hinge constructed and arranged to secure one of the first end or the second end of the strap to the housing so that the strap is moveable between an open position out of engagement with the product, and a closed position wherein the locking tab secures the strap about the product.

13. The anti-theft device of claim 12, wherein the end of the strap opposite the hinge supports one of the first portion or the second portion of the locking assembly.

14. The anti-theft device of claim 1, wherein the strap is adjustable about the product.

15. The anti-theft device of claim 14, wherein the first end of the strap is constructed and arranged to be insertable within a head supported on the second end of the strap.

16. The anti-theft device of claim 15, wherein the locking assembly includes a plurality of teeth disposed on the strap and a ratchet supported by the head, and wherein upon inserting the first end of the strap into the head the teeth supported on the portion of the strap that has been inserted into the head are lockingly engaged by the ratchet.

17. The anti-theft device of claim 16, wherein as the strap is adjusted around the product, the ratchet engages each of the plurality of teeth inserted within the head such that strap is tightened around the product in an irreversible manner.

18. The anti-theft device of claim 15, further comprising at least one holder supported on the housing and constructed and arranged to receive a portion of the strap there through, the holder being sized so that the head does not pass there through.

19. The anti-theft device of claim 1, wherein the housing includes a cavity constructed and arranged to support an electronic article surveillance sensor.

20. The anti-theft device of claim 1, in combination with an electronic article surveillance sensor.

21. The anti-theft device of claim 1, in combination with the product and wherein the product is a battery.

22. A method of using an anti-theft device to deter theft of a product, comprising the steps of:
providing an anti-theft tag including:
a) a housing including an opening configured and dimensioned to receive a portion of the product therein;
b) a strap including a first end and a second end opposite the first end, the strap being sized to fit around a portion of an outer surface of the product and constructed and arranged to secure the housing to the product;
c) a locking assembly including at least a first portion and at least a second portion, the first and second portions engaging each other in a locked position to deter removal of the anti-theft device; and
d) a detachment portion constructed and arranged to be severed by a consumer to remove the anti-theft device after purchase;
inserting a portion of the product through the opening of the housing;
positioning the strap around a portion of the outer surface of the product;
engaging the first portion of the locking assembly with the second portion of the locking assembly to secure the strap around the portion of the outer surface of the product in order to lock the housing to the product.

23. The method of claim 22, further comprising the step of adjusting the length of the strap around the portion of the outer surface of the product.
